(19) United States
(12) Patent Application Publication
(10) Pub. No.: US 2009/0324041 A1
(43) Pub. Date: Dec. 31, 2009

(54) APPARATUS FOR REAL-TIME 3D BIOPSY

(75) Inventors: RAMKRISHNAN NARAYANAN, NEVADA CITY, CA (US); YUJUN GUO, GRASS VALLEY, CA (US); JASJIT S. SURI, ROSEVILLE, CA (US)

Correspondence Address: MARSH, FISCHMANN & BREYFOGLE LLP, 8055 East Tufts Avenue, Suite 450, Denver, CO, 80237, US

(73) Assignee: EIGEN, LLC, Grass Valley, CA (US)

(21) Appl. No.: 12/359,029

(22) Filed: Jan. 23, 2009

Related U.S. Application Data
(60) Provisional application No. 61/062,009, filed on Jan. 23, 2008.

(51) Int. Cl. G06K 9/00; G06T 15/00

(52) U.S. Cl. 382/131; 345/419

(57) ABSTRACT

A method and apparatus are disclosed for performing software guided prostate biopsy to extract cancerous tissue. The method significantly improves on the current system by accelerating all computations using a graphical processing unit (GPU) keeping the accuracy of biopsy target locations within tolerance. The result is the computation of target locations to guide biopsy using statistical priors of cancers from a large population, as well as based on previous biopsy locations for the same patient, and finally via mapping protocols with predefined needle configurations onto the patient's current ultrasound image.

### CROSS-REFERENCE TO RELATED APPLICATION

This application claims priority and the benefit of the filing date under 35 U.S.C. 119 to U.S. Provisional Application No. 61/062,009, entitled, “AN APPARATUS FOR REAL-TIME 3D BIOPSY,” filed on Jan. 23, 2008, the entire contents of which are incorporated herein as if set forth in full.

### FIELD OF INVENTION

The present invention is directed to the registration of medical images. More specifically, the present invention is directed to surface registration of images in a parallel processing system that reduces the computational time required

### BACKGROUND OF THE INVENTION

A biopsy is recommended when a patient shows high levels of prostate specific antigen (PSA), which is often an indicator of prostate cancer (PCa). 3-D Transrectal Ultrasound (TRUS) guided prostate biopsy is one method to test for prostate cancer. The samples collected by the urologist may produce a false negative if the biopsy does not detect malignant tissues despite high PSA levels or other indicators of PCa (e.g. transurethral resection, digital rectal examination).

Traditional biopsy protocols most notably the systematic sextant biopsy protocol has a poor positive predictive value. Several studies have suggested the use of more optimal biopsy protocols based on the non uniform occurrence of cancers within the prostate but no ideal standard exists at this time. Previous biopsy locations may be used to guide current target selection (repeat biopsy), in addition to the use of a standard plan that attempts to place targets in regions statistically likely to develop cancer. A cancer atlas of the atlas with optimized plans based on cancer statistics from a cohort of prostatectomy specimen with cancers annotated by experts may additionally be used.

Repeat biopsy showing previous biopsy locations in the current anatomical context can help the urologist decide whether to revisit or avoid previous biopsy locations based on the pathology report from the previous biopsy. Standard plans show biopsy locations from various protocols positioned relevant to the current scan, while an atlas optimized biopsy plan operates essentially like a standard plan where it must be registered to the current scan for the biopsy locations to be meaningful. During the clinical procedure, atlas may be registered to a current TRUS image followed by biopsy core mapping onto the current scan. In addition to targeting guided by repeat biopsy and atlas, standard plans known to target high cancer zones may be mapped to a current patient scan using similar techniques.

The image processing involved to accomplish these 3D registration tasks are very computationally intensive making target selection guided by a) atlas, b) previously visited sites and/or c) standard plans difficult to achieve in real time by processing data on a CPU. It is important to minimize the computation time for several reasons. Long registration times can lead to patient anxiety, risk of motion that may invalidate the relevance of the TRUS image acquired and reconstructed to 3D, and longer biopsy procedures.

### SUMMARY OF THE INVENTION

There are generally two possible registration strategies: intensity-based method and feature based method. Intensity-based methods use original gray-scale values for registration, and no feature extraction is required. Feature-based methods use anatomical features extracted from the image. These features include control points, boundaries, and surfaces. In the present application a surface-based registration technique is utilized.

There are typically four stages involved in an imaged biopsy procedure: image acquisition, image segmentation, image registration, and biopsy navigation. The first stage has a constant operating time; the fourth stage depends on the number of biopsy sites planned. It is therefore important to make the segmentation and registration procedure real-time or near real-time. Graphics processing units (GPU) have now evolved into a computing powerhouse for parallel computation. The numerous multiprocessors, and fast memory units within the GPU may be favorably exploited to run large data parallel tasks simultaneously, and with high arithmetic intensity allowing the creation of several hundreds or thousands of data parallel threads.

The implementation of the surface-based registration and elastic warping using parallel computation is discussed in this patent in the context of prostate biopsy, though the scope of the patent is not limited to prostate biopsy alone. After the ultrasound scan is acquired, the prostate is first segmented using a segmentation technique. For repeat biopsy, the segmented surface from previous scan is registered to the surface segmented from the current scan. While for the registration of atlas information to a current scan, statistical shape-based registration is used. A similar strategy may be adopted for registering standard plans defined on the 3D atlas image as well. Based on the correspondence estimated from the registration, previous biopsy locations or optimized biopsy sites on atlas or standard plans are populated into the anatomical context of current scan.

In this application, the inventors present an implementation of surface-based registration algorithm using parallel computation that may be performed on a GPU. Also presented is an elastic warping solver in 3D to warp 3D volumes based on surface correspondences. The inputs are a current segmented prostate surface and a model surface (e.g., previous prostate surface, atlas surface etc). The inputs surfaces have vertices and facets defined (e.g., mesh surfaces). The output is a deformed mesh surface after registration. The deformation information (i.e, correspondences) generated from deforming the model mesh surface to the current mesh surface is used to warp 3D volumes after surface registration. That is, initially only the surfaces of 3D volumes (e.g., current prostate volume and a previous prostate volume) surfaces are used to determine correspondences. After determining these correspondences they are applied to elastically deform, for example, a previous volume to a current volume. In the procedure of registration, both local and global features are used by adjusting the searching resolution and step size. A parallel computation implementation not only makes the registration near real-time, but also facilitates the visualization of registration surface on screen.

The systems and methods (utilities) presented in this patent allow for reducing biopsy procedure times. Three procedures which may benefit from the presented utilities includes: statistical Atlas based warping to map optimal biopsy sites defined on the atlas space to the current anatomical volume; mapping of biopsy locations of the same patient from a previous visit to the current anatomical volume; and mapping of planned biopsy sites, e.g. sextant, extended 12 core systematic biopsy, etc on to the current anatomical volume. All three methods provide useful information to help guide biopsy target selection. They require the registration of surfaces followed by interpolating needle locations from one image to another.

First, a 3D Transrectal Ultrasound (TRUS) image of the prostate is acquired. The acquired images are converted to 3D orthogonal voxel data having equal resolution in all three dimensions. The prostate is then segmented from the 3D TRUS image. The outline on the segmented image is triangulated to yield a mesh surface in the form of vertex points, and connectivity information in the form of faces. This resulting mesh surface describes the boundary of the prostate in the image and provides the anatomical description for all procedures following. All three procedures mentioned above use this mesh surface (i.e, current boundary) to map information contained relevant to a different surface onto the currently segmented surface or volume.

Surface registration is carried out to register one surface to another (model and target). One of these surfaces is called the model and the other is called the target. An important step in the warping of the model to the target is the computation of nearest neighbors for each vertex in the model to the target and vice versa. Since the computation of nearest neighbors in the corresponding surface is a parallel operation, these computations are performed as independent threads, running simultaneously on the several multiprocessing units of a GPU. The force applied to warp the model surface to register with the target is computed by finding the nearest neighbor in the target vertex for every warped model vertex. This search method is exhaustive and must be done for each model vertex. Similarly, the nearest vertex in the warped model instance for each target vertex must be done to find the reverse forces. These computed forward and reverse forces may be used to warp the model iteratively. The search functions for finding nearest vertices in the forward and reverse directions may be directly implemented on the GPU. This is because every search on the vertex is independent from the next in the entire vertex set. The task may thus be split into several hundreds or possibly thousands of threads (depending on the number of searches) that can each be executed independently. Such registration defines the correspondence between the model and the target.

A further aspect, which may also be implemented in a GPU, is the elastic warping of 3D volumes given the surface correspondences estimated from registration. An iterative parallel relaxation algorithm is implemented where the nodes in a 3D mesh associated with the 3D volumes depend on the position of nodes from the previous iteration. Thus the computation of new node positions in the current 3D mesh is completely independent for each node (each depending only on the previous 3D mesh iterates).

### BRIEF DESCRIPTION OF THE DRAWINGS

For a more complete understanding of the present invention and further advantages thereof, reference is now made to the following detailed description taken in conjunction with the drawings in which:

FIG. 1 illustrates an overview of the system, including image acquisition, segmentation, registration, and interpolation.

FIG. 2 illustrates an image acquisition system.

FIG. 3 illustrates a mesh surface of a 3D volume.

FIGS. 4A-4D illustrate an overall process of warping a first 3D volume to a second 3D volume.

FIG. 5 illustrates the orientation of two 3D mesh surfaces prior to registration.

FIG. 6 depicts the implementation of the functions for registration and interpolation on a GPU.

FIG. 7 describes the elastic warping procedure executed on the GPU FIG. 2 illustrates

FIG. 8 illustrates an image split into sub-blocks whose nodes may be independently updated on each of the GPU's several multiprocessing units.

FIG. 9 shows a parallel relaxation algorithm in 2D where each node in the current iterate of the mesh depends only on previous iterates of the neighboring nodes.

### DETAILED DESCRIPTION

Reference will now be made to the accompanying drawings, which assist in illustrating the various pertinent features of the various novel aspects of the present disclosure. Although the invention is described primarily with respect to an ultrasound imaging embodiment, the invention is applicable to a broad range of imaging modalities and biopsy techniques, including MRI, CT, and PET, which are applicable to organs and/or internal body parts of humans and animals. In this regard, the following description is presented for purposes of illustration and description. Furthermore, the description is not intended to limit the invention to the form disclosed herein. Consequently, variations and modifications commensurate with the following teachings, and skill and knowledge of the relevant art, are within the scope of the present invention.

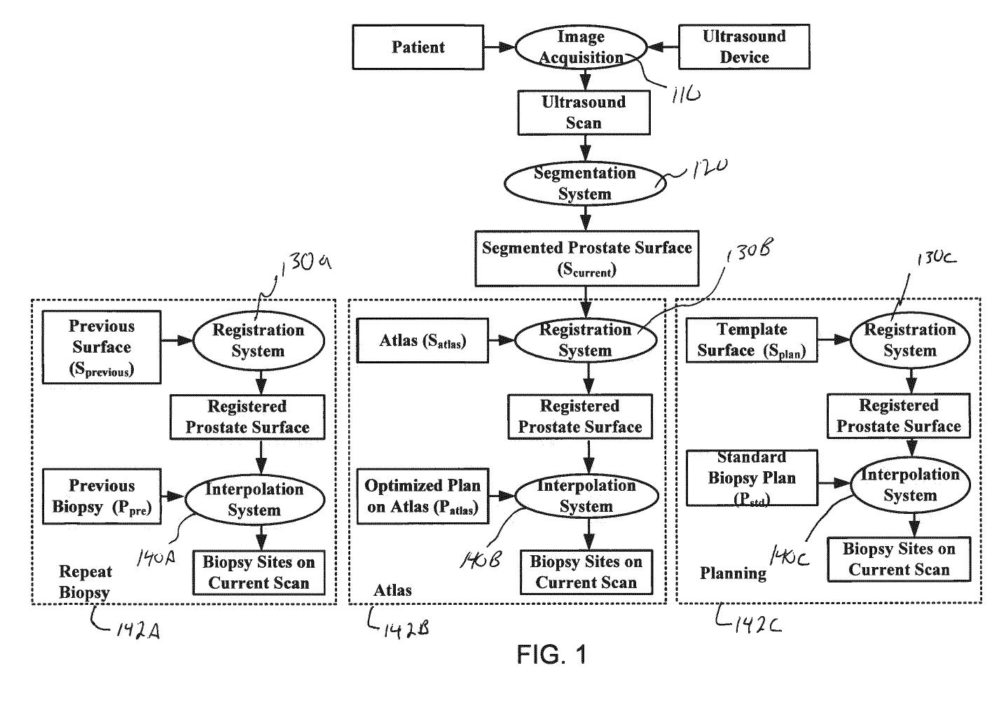

In one embodiment of the present invention, a needle positioning system to aid a urologist in rapidly finding biopsy target sites is presented. The system enhances the urologist's workflow by accelerating the compute time for image registration algorithms by efficiently running such algorithms in parallel processing paths on, for example, a graphics processing unit or GPU. Generally, the system and methods disclosed herein are utilized for speeding up biopsy procedures. As illustrated in FIG. 1, the system 100 generally has four stages: image acquisition 110, image segmentation 120, image registration 130, and interpolation 140.

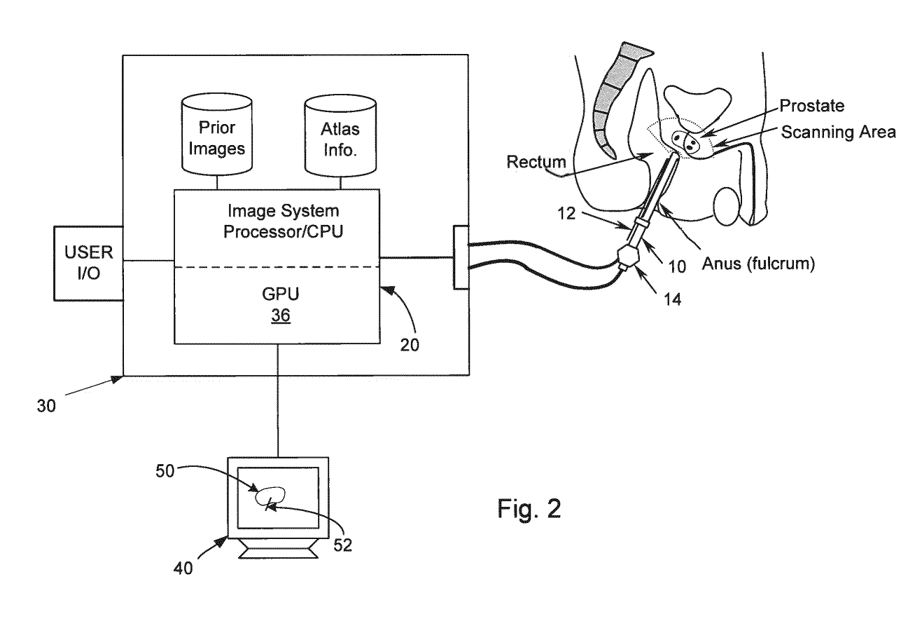

Image acquisition 110 is illustrated in FIG. 2 where an ultrasound probe 10 has a biopsy needle assembly 12 attached to its shaft inserted into the rectum from the patient's anus. The illustrated probe 10 is an end-fire transducer that has a scanning area of a fan shape emanating from the front end of the probe (shown as a dotted outline). The probe handle is held by a robotic arm (not shown) that has a set of position sensors 14. These position sensors 14 are connected to the computer 20 of the imaging system 30 via an analog to digital converter. Hence, the computer 20 has real-time information of the location and orientation of the probe 10 in reference to a unified Cartesian (x, y, z) coordinate system. In the presented embodiment, the imaging system also includes a graphics processing unit (GPU). A plurality of images may be utilized to generate a 3D image of the prostate.

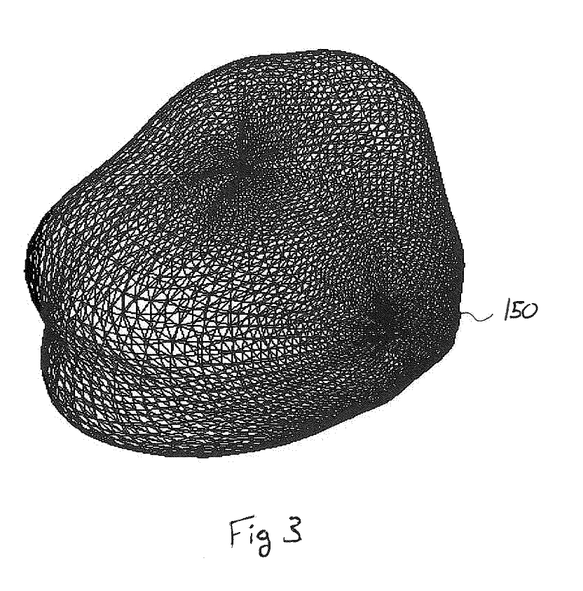

Once the acquired images are converted to 3D orthogonal voxel data having equal resolution in all three dimensions, the prostate may be segmented from the 3D TRUS image. Such segmentation may be performed in any known manner. One such segmentation method is provided in co-pending U.S. patent application Ser. No. 11/615,596, entitled “Object Recognition System for Medical Imaging” filed on Dec. 22, 2006, the contents of which are incorporated by reference herein. The outline on the segmented image is triangulated to yield a current mesh surface 150 (i.e, S_{current}) in the form of vertex points and connectivity information in the form of faces. FIG. 3 illustrates such a mesh surface 150 formed of vertex points and faces. This resulting mesh surface describes the boundary of the prostate in the image and provides the anatomical description for all procedures following. All three procedures mentioned herein use this current mesh surface 150 to map relevant information contained in a different surface(s) onto the currently segmented surface and/or into the current prostate volume.

With the dimensions of the probe 10 and needle assembly 12 taken into the calculations, the 3D position of the needle tip and its orientation is known and can be displayed on the current image. The ultrasound probe 10 sends signal to the image guidance system 30, which may be connected to the same computer (e.g., via a video image grabber) as the output of the position sensors 14. In the present embodiment, this computer is integrated into the imaging system 30. The computer 20 therefore has real-time 2D and/or 3D images of the scanning area in memory 22. The image coordinate system and the robotic arm coordinate system are unified by a transformation. Using the acquired 2D images, a prostate surface 50 (e.g., 3D model of the organ) and biopsy needle 52 are simulated and displayed on a display screen 40 with their coordinates displayed in real-time. A biopsy needle may also be modeled on the display, which has a coordinate system so the doctor has the knowledge of the exact locations of the needle and the prostate.

The computer system runs application software and computer programs which can be used to control the system components, provide user interface, and provide the features of the imaging system. The software may be originally provided on computer-readable media, such as compact disks (CDs), magnetic tape, or other mass storage medium. Alternatively, the software may be downloaded from electronic links such as a host or vendor website. The software is installed onto the computer system hard drive and/or electronic memory, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having computer-readable program code embodied therein. The software contains one or more programming modules, subroutines, computer links, and compilations of executable code, which perform the functions of the imaging system. The user interacts with the software via keyboard, mouse, voice recognition, and other user-interface devices (e.g., user I/O devices) connected to the computer system.

At least three separate procedures 142a-c can be performed to map information onto the current anatomical volume. As illustrated in FIG. 1 these procedures include: statistical atlas based warping 142b to map optimal biopsy sites defined on the atlas space to the current anatomical volume; repeat biopsy 142a to allow mapping of previous biopsy locations of the same patient from a previous visit to the current anatomical volume; and mapping of planned biopsy sites 142c (e.g. sextant, extended 12 core systematic biopsy, etc) on to the current anatomical volume. All three methods provide useful information to help guide biopsy target selection. They require the registration of surfaces followed by interpolating 140a-c locations from one anatomy to another. The registration and interpolation architectures discussed are implemented on a GPU.

The first system consists of a 3D statistical atlas image consisting of cancer probability priors (e.g., statistical information) is constructed from a database of 3D reconstructed histology specimen with known boundaries of cancers. In one embodiment, a shape model including statistical information may be generated that may subsequently be fit to a patient prostate image or volume. Such a process is set forth in co-pending U.S. patent application Ser. No. 11/740,807 entitled “IMPROVED SYSTEM AND METHOD FOR 3-D BIOPSY,” having a filing date of Apr. 26, 2006, the entire contents of which are incorporated herein by reference. In addition to the statistical information in the shape model, the surface mesh of the atlas may include optimized needle locations (e.g. 7 or 12 core optimized) that maximize the detection rate of cancer. Herein, the atlas image is denoted as Sₐₜₗₐₛ, and the optimized locations as Pₐₜₗₐₛ. Generally the atlas image is registered to S_{current} first and then the optimized needle locations Pₐₜₗₐₛ can be mapped onto S_{current} to help biopsy target selection.

The second system consists of one or more previous surfaces segmented exactly as described for S_{current} where such previous surfaces are computed during the patient's previous visits. Such previous surfaces may include previous biopsy locations. These previously segmented surfaces are denoted Sₚᵣₑᵥᵢₒᵤₛ. It should be appreciated that the imaging modality of previous surface may not be limited to Ultrasound. It also could be other anatomical imaging techniques, such as MRI, CT, or functional imaging techniques, such as PET, SPECT, or magnetic resonance spectroscopy (MRS), as long as the imaging techniques allow for 3-D segmented surfaces. The goal of this system is to register Sₚᵣₑᵥᵢₒᵤₛ to S_{current}, and then previous biopsy locations defined on Sₚᵣₑᵥᵢₒᵤₛ (i.e, Pₚᵣₑ) can be mapped to current scan to help guide target selection. This system is referred to as a repeat biopsy system. Such a system is set forth in co-pending U.S. patent application Ser. No. 11/750,854 entitled “REPEAT BIOPSY SYSTEM,” having a filing date of May 18, 2007, the entire contents of which are incorporated herein by reference.

The third system consists of needle locations defined on a template surface, Sₚₗₐₙ. This surface could very well be the surface of the atlas. These needle locations, P_{std}, correspond to commonly used plans like sextant and others that need to be mapped onto the current anatomy. The needle locations for all these plans are known prior to registration in the template surface. After template surface Sₚₗₐₙ is registered to S_{current}, these locations defined in P_{std} are populated to anatomical context of current scan. In FIG. 1 this system is highlighted and labeled as “Planning”.

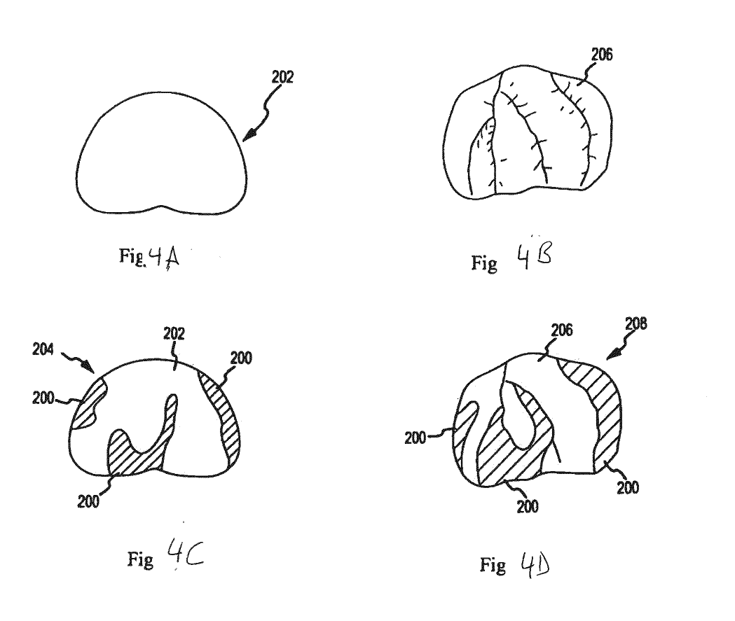

FIGS. 4A-4D graphically overview the registration process where an atlas model is applied to a current prostate volume. Though illustrated as 2D figures, it will be appreciated that the atlas shape model and prostate image may be three dimensional. Initially, the atlas shape model 202 is provided. See FIG. 4A. Statistical information 200 (e.g., ground truth data) corresponding to a current patient (e.g., based on demographics, PSA, etc) is provided on and/or within with the shape model 202. See FIG. 4B. The model may then be applied (e.g., fit) to an acquired ultrasound prostate image 206. See FIG. 4C. The result of this fitting procedure is also the transfer of statistical information to the prostate image 206 of the patient. That is, the statistical information may be applied to the prostate image 206 of the patient to provide a combined image with statistical data 208. See FIG. 4D. The combined image 208 may be used to define regions of interest on the prostate of the current patient that have, for example, higher likelihood of cancer. Accordingly, a urologist may target such regions for biopsy.

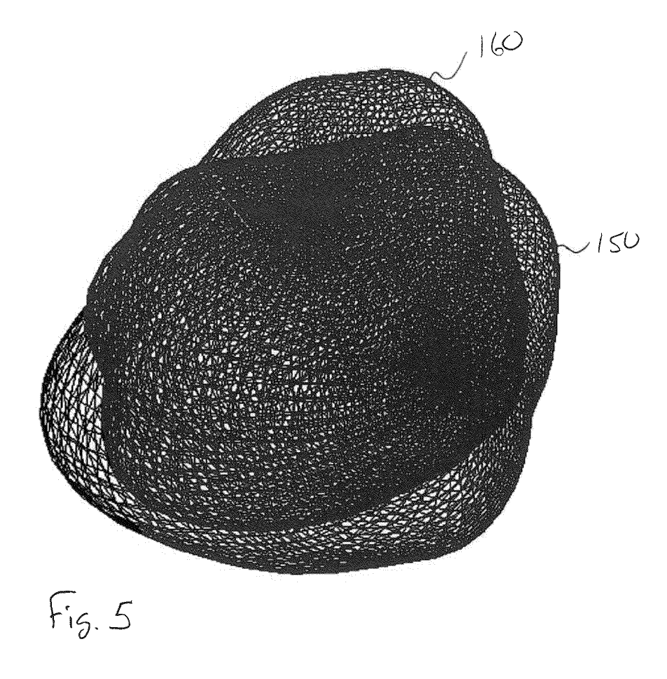

The difficulty with the above-noted procedure is the timely registration (i.e, alignment and fitting) of the images. To reduce the time required for such registration, the presented systems and methods use surface registration of mesh surfaces defined by 3D volumes (e.g., current and previous prostate volumes) to determine deformation parameters. These deformation parameters from the surface mesh registration are then used to register one volume to another (model and target). For example, for atlas registration, the mean shape of the shape model needs to be registered to S_{current} or for repeat biopsy, the previous surface segmented Sₚᵣₑᵥᵢₒᵤₛ needs to be registered to the current image S_{current}. As illustrated in FIG. 5 one of these surfaces is called the model 160 and the other is called the target 150 (S_{current}). As shown, the temporally distinct surfaces are not aligned and the model surface 160 has to be deformed to match the boundary established by the target surface 150. In the present embodiment, where mesh surfaces formed of multiple faces and vertices, an important step in the warping of the model 160 to the target 150 is the computation of nearest neighbors for each vertex in the model to the target and vice versa. The force applied to warp the model surface to register with the target surface is computed by finding the nearest neighbor in the target vertex for every warped model vertex. Often, such surfaces have in excess of three or four thousand vertices. This search method is exhaustive and must be done for each model vertex typically in a sequential fashion on a CPU. Further, this is usually an iterative process that is repeated multiple times (e.g. dozens or even hundreds or iterations) to achieve a desired convergence of the model 160 to the target 150. Accordingly, performing such registration on a CPU can be time consuming due to the intensive computational requirements. It will be appreciated that it is important to reduce the computation time for several reasons. Long registration times can lead to patient anxiety, risk of motion that may invalidate the relevance of the current image acquired and reconstructed to 3D, and longer biopsy procedures.

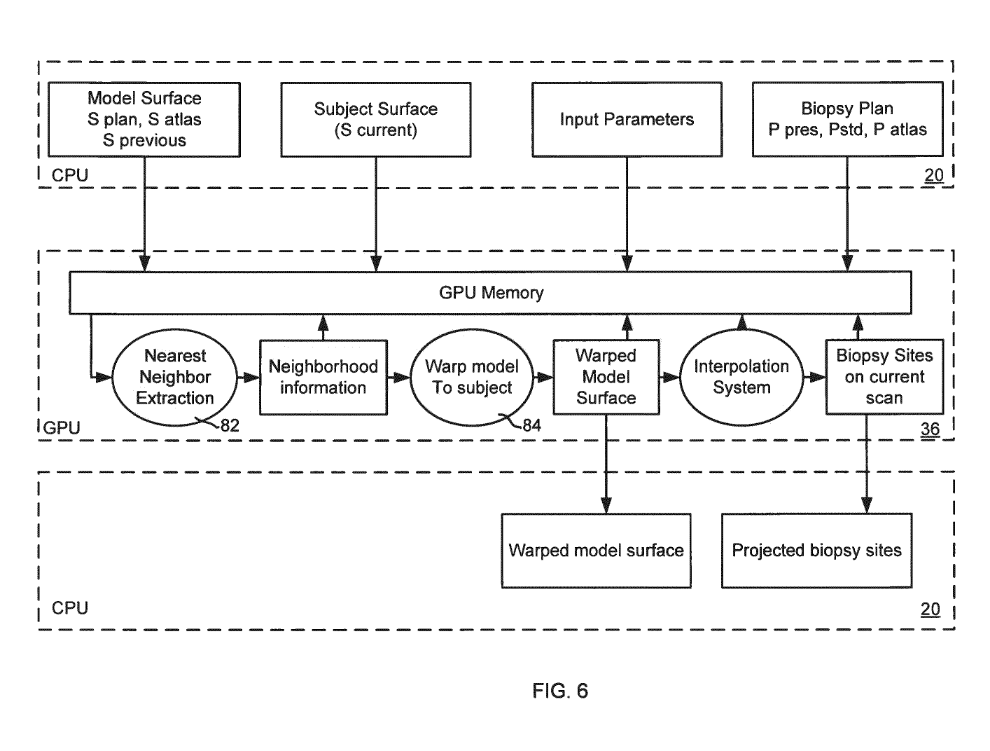

The presented surface registration method allows parallel computing that significantly reduces the computing time necessary for registration of the mesh surfaces. Generally, the computation of nearest neighbors is a parallel operation, and it has been recognized that these computations may be performed as independent threads, running simultaneously on the several multiprocessing units on a GPU. See FIGS. 1 and 6. A graphics processing unit or GPU (also occasionally called visual processing unit or VPU) is a dedicated graphics rendering device. Modern GPUs are very efficient at manipulating and displaying computer graphics, and their highly parallel structure makes them more effective than general-purpose CPUs for a range of complex algorithms. A GPU can sit on top of a video card, or it can be integrated directly into the motherboard. In the present embodiment, such a GPU 36 is integrated into the imaging device 30.

As shown in FIG. 6, the GPU is operative to receive model surface and the current surface in to memory along with any additional necessary input parameters. More particularly, the GPU is operative to receive model and target vertex lists from the CPU to be stored on the GPU at every iteration of surface registration, or receive only model vertex lists iteratively and copy the target vertex list at the beginning of the program since the vertex data for the target never changes throughout the registration. That is, all necessary information is copied to GPU memory before execution, to reduce the communication cost between CPU and GPU. The registered surface and interpolated biopsy sites are copied back to CPU when complete. This speeds registration by potentially copying vertex data to a parallel data cache to speed memory access.

The force applied to warp the model surface to register with the target is computed by finding the nearest neighbor 84 (see FIG. 6) in the target vertex for every warped model vertex. Similarly, the nearest vertex in the warped model instance for each target vertex must be done to find the reverse forces. These computed forward and reverse forces may be used to warp 84 the model iteratively. The search functions for finding nearest vertices in the forward and reverse directions may be directly implemented on the GPU. This is because every search on the vertex is independent from the next in the entire vertex set. The task may thus be split into several hundreds or possibly thousands of threads running searches for each vertex independently on the GPU (depending on the number of searches) that can each be executed independently.

### Surface Registration

In order to register the two mesh surfaces 160, 150 (hereafter mesh surfaces A and B) to each other, the vector connecting each vertex on mesh A to its nearest neighboring vertex in mesh B must be computed (Ai->Bj, where j is the closest vertex in B to vertex i in A). This is called the forward force. Similarly the vector connecting each vertex in mesh B to its nearest neighboring vertex in mesh A is computed (Ak->Bl), where ‘k’ is the closest vertex in A to vertex ‘l’ in B). This is called the reverse force. A combination of these forces, along with suitable smoothness terms are used to deform mesh A to iteratively align itself with mesh B to result in a warped surface mesh A′.

The computation of these individual vectors corresponding to each vertex in the estimation of both the forward and reverse force are completely independent, i.e. the vector calculation for each vertex does not affect the vector calculation for a different vertex. Once all vectors are found in the forward and reverse directions (resulting in computation of forward and reverse forces), mesh surface A can be warped to get mesh surface A¹. In the next iteration, mesh surface A¹ is warped to get mesh surface A² and so on until the magnitude of forces between surface A^{k} and surface B are small. That is, until surfaces converge to a desired degree.

In the present embodiment, the GPU is called at each iteration to estimate these vectors sequentially. A first GPU kernel (function) computes the forward force, while a second kernel estimates the reverse force. The computation of the forward force is described below. The reverse force is similarly calculated going the other direction.

### Surface Registration Implementation on the GPU (Forward Force Estimation)

For purposes of discussion it is assumed there are ‘N’ vertices describing surface A, and ‘M’ describing surface B. Since the vector calculations for each of these ‘N’ threads is independent each vector corresponding to a vertex in surface A can be treated as a thread resulting in the initialization of ‘N’ threads. Each of these threads will loop through each vertex in surface B, and find the closest vertex in surface B to the vertex in surface A pertaining to the current thread. The GPU cycles through all these threads by allocating them on various multiprocessors.

A kernel is set up in this case calculation of forward force where each thread can run theoretically in parallel, and the GPU processes these threads. Each thread will run the same kernel (that does the nearest neighbor searching) but working on a different vertex in surface A.

Once the surface correspondences are estimated based on the description above, the volume containing surface A, is warped to the volume containing surface B elastically. This is done by solving the elastic partial differential equation applying the surface correspondence boundary conditions (i.e. the correspondence between A and A^{k}).

The equations are solved via parallel Jacobi relaxation iteratively where each voxel's position is updated based on the neighboring voxel positions from the previous iteration. Since the updates for each voxel for the current iteration are completely independent, all updates can be performed simultaneously making this an ideal candidate for GPU processing.

### GPU Implementation

A GPU kernel (function) was implemented that took a single voxel and applied the updated rule (to move the voxel to a new position). As many threads as the number of voxels in the image were initialized and each of these threads called the same kernel but operating on different voxels. Once all voxels were updated, this became the previous voxel position for the next set of voxel updates. Also since neighboring voxels tend to access the same neighboring voxel positions, these positions may be loaded in to the GPU's fast parallel data cache for fast access.

One exemplary implementation may be as follows (to deform a 64×64×64 3D image): The image is split into non-overlapping sub-blocks (8×8×8), consisting of 512 voxel locations each updated by its own thread. Updates to the position of each voxel are made based on the previous voxel position of its neighbors. The non-overlapping updates were reassembled at the end of each iteration to prevent inconsistencies. Each thread computes the iterative warp in x, y and z via parallel Jacobi relaxation and running 500 iterations in total.

### GPU Interpolation

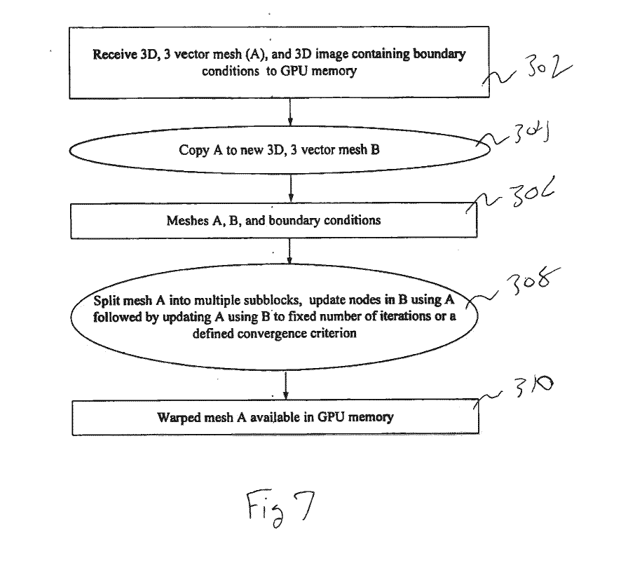

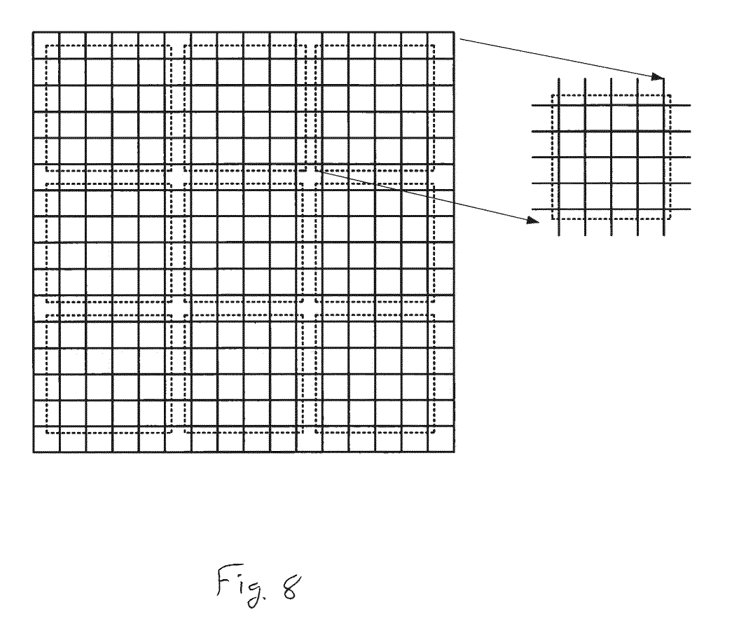

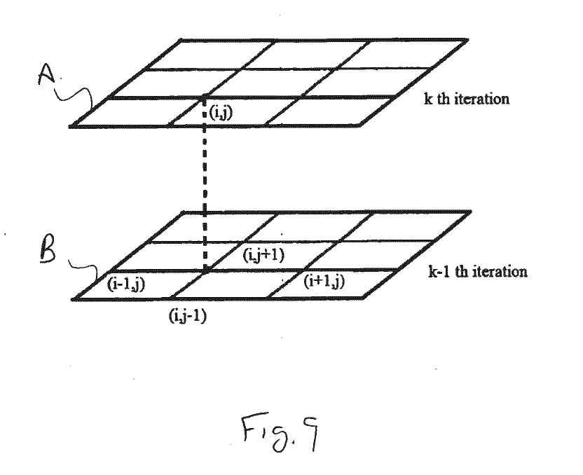

The second GPU implementation is the elastic warping of 3D volumes given surface correspondences estimated from registration. See FIG. 7. Initially, the warping system receives (302) the a 3D, 3 vector (for x, y and z) mesh of the original model image (3D model mesh) and the current 3D image with boundary conditions (i.e, identified from surface registration) at surface boundaries on to the GPU. A second copy of the 3D model mesh is generated (304). These two model meshes and the boundary conditions are provided (306) to drive the deformation such that the model volume can be matched to the current volume. The 3D meshes are split into multiple subblocks (308) for parallel processing. See FIG. 8. The elastic warping system solves the deformation via parallel relaxation where each node in the 3D mesh is updated entirely based on its corresponding neighborhood nodes from the previous iteration resulting in independent computations on the nodes. Every node is updated independently, but also every x, y and z positions on every node are independently updated at every iteration of parallel relaxation. All updates must occur (synchronization) before the next iteration may begin. See FIG. 9. Using the two meshes, e.g., meshes A and B, where both are initialized to identity at the start. At subsequent iterations B is updated based on node positions in A and vice versa consecutively until a defined criterion for convergence. This facilitates the existence of a previous mesh and an updated mesh and prevents overwriting. Copying the previous mesh to a fast data parallel cache of the GPU speeds up data access. This can be accomplished by moving blocks of data in piecemeal until all blocks are updated and saved in the updated mesh. This is repeated at every iteration.

Once convergence is achieves, a warped 3D mesh of the model surface is generated (310) and saved in memory. Accordingly, the warped model volume may be displayed on the current volume such that information associated with the model may be displayed in the framework of the current volume.

1. A method for registering prostate images in a medical imaging device, comprising:
obtaining a current 3D prostate image from a medical imaging device;
accessing a second 3D prostate image from a computer readable media;
in a processing system of the medical imaging device:
segmenting a first prostate volume in said first medical image;
segmenting a second prostate volume is said second medical image;
generating first and second mesh surfaces associated with surfaces of said first and second prostate volumes; and
conforming said second mesh surface to said first mesh surface to define surface correspondences between said first and second 3D images.

2. The method of claim 1, further comprising:
using said surface correspondences to deform said second prostate volume to said first prostate volume; and
generating and outputting a display of said first and second prostate volumes disposed in a common frame of reference.

3. The method of claim 1, wherein generating said mesh surfaces comprises:
triangulating each said surface to produce a surface having vertex points and faces.

4. The method of claim 3, wherein conforming said second mesh surface comprises:
calculating neighboring vertexes for each vertex point in said first and second mesh surfaces.

5. The method of claim 4, wherein calculating is performed in a parallel processor.

6. The method of claim 5, wherein said parallel processor is a GPU processor.

7. The method of claim 2 wherein deforming comprises:
using said surface correspondences to drive warping over the entire second prostate volume

8. The method of claim 7, further comprising:
using an iterative parallel relaxation algorithm where the nodes in a 3D mesh associated with said second prostate volume depend on the position of nodes from a previous iteration.
